(19) United States
(12) Patent Application Publication
(10) Pub. No.: US 2025/0073577 A1
(43) Pub. Date: Mar. 6, 2025

(54) Controller Having A Heat Transfer Module

(71) Applicant: Sony Interactive Entertainment Europe Limited, London (GB)

(72) Inventors: Jun Yen Leung, London (GB); Maurizio Cerrato, London (GB); Lawrence Martin Green, London (GB)

(73) Assignee: Sony Interactive Entertainment Europe Limited, London, GB (GB)

(21) Appl. No.: 18/819,260

(22) Filed: Aug. 29, 2024

(30) Foreign Application Priority Data
Aug. 31, 2023 (GB) 2313299.6

(51) Int. Cl. A63F 13/28

(52) U.S. Cl. CPC A63F 13/28

(57) ABSTRACT

A controller for a video game system is provided. The controller comprises an exterior case including a handle, the handle comprising a first region and a second region, wherein the handle is configured to be held by a user. The controller further comprises a heat transfer module comprising a cooling region and a heating region, wherein the heat transfer module is configured to transfer heat from the cooling region to the heating region. The cooling region of the heat transfer module is arranged at the first region of the handle, and the heating region of the heat transfer module is arranged at the second region of the handle. This controller locally heats and cools a user when they hold the handle of the controller.

### CROSS-REFERENCE TO RELATED APPLICATION

The present application claims priority from United Kingdom Patent Application No. GB2313299.6 filed Aug. 31, 2023, the disclosure of which is hereby incorporated herein by reference.

### FIELD OF THE INVENTION

The present invention relates to the field of controllers. In particular, the invention relates to controllers for video game systems.

### BACKGROUND

Many video game systems include a controller as an input device, or an input/output device, enabling a user (i.e. player) to interact with a video game application (equivalently, ‘video game’) running on the system. The controller serves as a bridge between the player's actions and the virtual world within the game. Typically, a video game controller will include various buttons, triggers, analogue sticks, directional pads, and sometimes motion sensors or touch-sensitive surfaces. However, controllers come in a variety of shapes, sizes, and functionalities, tailored to suit different types of video game systems, video game applications, and player preferences.

Most controllers are designed to be held by the player and operated using their hands. However, due to factors which vary across the hands of a user such as blood circulation, surface area, and insulation, this results in large temperature differences in difference areas of the hands. The most notable difference is between the fingers and the palms, where the fingers are significantly colder than the palms, and this is particularly noticeable in winter when the fingers are too cold and summer when the palms are too hot. This can lead to discomfort and diminished performance of the user and can even impact the longevity and performance of the controller itself.

Players often resort to external solutions such as wearing blankets or holding the controller and their hands in front of a fan. However, these solutions are not ideal as they require additional effort on the part of the user and lack the capacity to adapt to changing thermal conditions without even further effort from the user. Consequently, there is a clear need for a solution which optimises temperature distribution across the controller and particularly across the hand-grip regions of the controller.

### SUMMARY OF INVENTION

In a first aspect of the invention, there is provided a controller for a video game system, the controller comprising: an exterior case including a handle, the handle comprising a first region and a second region, wherein the handle is configured to be held by a user; a heat transfer module comprising a cooling region and a heating region, wherein the heat transfer module is configured to transfer heat from the cooling region to the heating region; wherein the cooling region of the heat transfer module is arranged at the first region of the handle, and the heating region of the heat transfer module is arranged at the second region of the handle.

In this way, when a user holds the handle of the controller, heat is transferred from the first region of the handle to the second region of the handle, thereby locally cooling the user where they are contacting the first region and locally heating the user where they are contacting the second region. That is, the controller is configured to simultaneously heat and cool the user holding the controller, thereby resolving a problem where, for example, the user has warm palms and cold fingers.

Furthermore, by transferring the inherent heat of the user from one area to another, the controller is able to simultaneously heat and cool the user holding the controller without requiring additional components to generate heat (such as a resistive or inductive heater) or extract heat (such as a refrigeration module). This reduces the number of components used in the controller, saving space and weight as well as reducing cost.

Preferably, the first region of the handle is a palm region configured to contact the palm of the user when the controller is held, and the second region of the handle is a finger region configured to contact at least one finger of the user when the controller is held, such that the heat transfer module is configured to transfer heat from the palm region to the finger region.

Controllers are normally configured to be held by the user in a specific intended manner so that input elements of the controller may be easily actuated by the user, and to ensure the comfort of the user while using the controller. Therefore, a handle of a controller may have a palm region which is configured to contact the palm of a user's hand when they hold the controller (more specifically, when the user holds the handle of the controller) and a finger region which is configured to contact one or more fingers of the same hand when they hold the controller.

By having the first region of the handle being a palm region, and the second region of the handle being a finger region, the controller of the first aspect is configured to transfer heat from the palm region to the finger region; thereby cooling the palm of a user and warming their finger(s).

Optionally, the heat transfer module is housed within the exterior case.

That is, the exterior case defines an internal cavity and the heat transfer module is arranged fully internally within this cavity and so is housed within the exterior case of the controller. A further component such as the exterior case or a surface heat conducting component(s) may be configured to facilitate heat transfer through the exterior case between the first region and the cooling region, and between the second region and the heating region. For example, the exterior case may have a reduced thickness in at least portions of the first region and/or the second region relative to other areas of the exterior case.

In this way, the heat transfer module can transfer heat from the cooling region to the heating region, thereby locally cooling and heating the user where they hold the controller, while being protected by the exterior case of the controller. This increases the longevity of the heat transfer module and the controller.

Optionally, the cooling region and the heating region of the heat transfer module are arranged on the exterior of the controller, and the heat transfer module extends through the controller between the cooling region and the heating region.

It will be appreciated that this can be implemented in various configurations. For example, the heat transfer module may be integral with the handle such that the cooling region is at least a portion of the first region, and the heating region is at least a portion of the second region. In another example, the first region and the second region are openings or holes in the exterior casing through which the cooling region and heating region respectively extend. Each of the first and second regions may be either a single opening in the exterior case or a series of openings with the exterior case forming a grid or mesh-like structure in the first and second regions.

In this way, the efficiency of heat transfer is increased due to facilitating direct contact between the user and the heat transfer module.

Optionally, the heat transfer module comprises a thermoelectric cooler. That is, the cooling region of the heat transfer module is a cooling region of the thermoelectric cooler, and the heating region of the heat transfer module is a heating region of the same thermoelectric cooler.

Thermoelectric coolers (also known as Peltier devices) are particularly advantageous for use as the heat transfer module as they can be flexibly shaped with a compact structure. Furthermore, thermoelectric coolers contain no moving parts or liquids, meaning they have very long lifespan and there is no risk of liquid leakage damaging the controller. The thermoelectric cooler may be a single stage thermoelectric cooler or a multi-stage thermoelectric cooler.

Preferably, the thermoelectric cooler is powered by a same battery of the controller which powers other elements of the controller.

Optionally, the heat transfer module comprises a passive heat exchanger, the passive heat exchanger having a higher heat transfer coefficient than the handle of the controller. That is, the cooling region of the heat transfer module is a cooling region of the passive heat exchanger, and the heating region of the heat transfer module is a heating region of the passive heat exchanger.

The heat transfer coefficient of the passive heat exchanger being higher than that of the handle means that heat will move more readily across the heat transfer module than it will the handle. In this way, the heat transfer module is able to provide the advantageous cooling and/or heating effects discussed above without requiring any additional power.

The passive heat exchanger may comprise a solid heat conductor extending between the heating region and the cooling region. In this way, the passive heat exchanger has no moving parts or liquids, providing a long lifespan with no risk or liquid leakage.

Alternatively, or in addition, the passive heat exchanger may comprise a sealed reservoir extending between the heating region and the cooling region, the sealed reservoir containing a heat transfer liquid having a higher heat transfer coefficient than the handle of the controller. In this way, heat is efficiently dispersed from the cooling region to the heating region through the reservoir.

Preferably, the controller further comprises a temperature sensor configured to measure the temperature of at least one of the first region of the handle, and the second region of the handle.

This is particularly beneficial when the heat transfer module can be selectively activated and deactivated, such as a powered thermoelectric cooler, as the heat transfer module may be configured to activate when the first region is above a first threshold temperature and/or when the second region is below a second threshold temperature. In this way, the heat transfer module is only used when needed to heat and/or cool the user and so the power used by the heat transfer module is reduced.

The heat transfer module of the controller may comprise both the thermoelectric cooler and the passive heat exchanger as described above. In this way, the passive heat exchanger may continuously warm and cool the user, and the thermoelectric cooler can be selectively activated when a greater rate of heat transfer is needed.

Optionally, the handle is a first handle, and the controller further comprises: a second handle comprising a third region and a fourth region, wherein the second handle is configured to be held by a user at the same time as the first handle; wherein the heat transfer module comprises a second cooling region and a second heating region, wherein the heat transfer module is configured to transfer heat from the cooling region and the second cooling region to the heating region and the second heating region; wherein the second cooling region is arranged at the third region, and the second heating region is arranged at the fourth region.

In this way, the heat transfer module may heat and cool both the first handle of the controller and the second handle of the controller.

Optionally, the handle is a first handle, and the controller further comprises: a second handle comprising a third region and a fourth region, wherein the second handle is configured to be held by a user at the same time as the first handle; and a second heat transfer module comprising a second cooling region and a second heating region, wherein the second heat transfer module is configured to transfer heat from the second cooling region to the second heating region; wherein the second cooling region is arranged at the third region, and the second heating region is arranged at the fourth region.

In this way, the heat transfer modules can heat and cool both the first handle of the controller and the second handle of the controller independently of each other.

It will be appreciated that the preceding disclosure of the invention in relation to the first handle is also applicable to the second handle. For example, the third region may be a second palm region and the fourth region a second finger region. Similarly, the disclosure of the invention in relation to the heat transfer module is also applicable to the second heat transfer module. For example, the second heat transfer module may comprise a thermoelectric cooler and/or a passive heat exchanger as described above in relation to the first heat transfer module.

Preferably, the controller further comprises a PCB housed within the exterior case, and a thermal insulator arranged between the heat transfer module and the PCB.

The printed circuit board (PCB) comprises important circuitry for the operation of the controller, for example the central processing unit (CPU) and connectors to input elements such as analogue sticks or buttons. Arranging a thermal insulator between the heat transfer module and the PCB will protect the PCB and circuitry from temperature variations caused by the heat transfer module, thereby increasing the longevity of the controller and the magnitude of heating and cooling the heat transfer module can safely achieve.

Preferably, the controller is a gamepad, a joystick, a steering wheel, a yoke, or a remote.

According to a second aspect, there is provided a video game system comprising the controller of the first aspect.

Additional aspects, advantages, features and objects of the present invention will be made apparent from the drawings and detailed description of the illustrative embodiments construed in conjunction with the appended claims that follow.

It will be appreciated that features of the present invention are susceptible to being combined in various combinations without departing from the scope of the present disclosure as defined by the appended claims.

### BRIEF DESCRIPTION OF DRAWINGS

Embodiments of the invention are described below, by way of example only, with reference to the accompanying drawings, in which:

FIG. 1A is a plan view of the front of a controller for a video game system;

FIG. 1B is a plan view of the back of a controller for a video game system; and

FIG. 2 is a cross-sectional view of a controller for a video game system.

### DETAILED DESCRIPTION

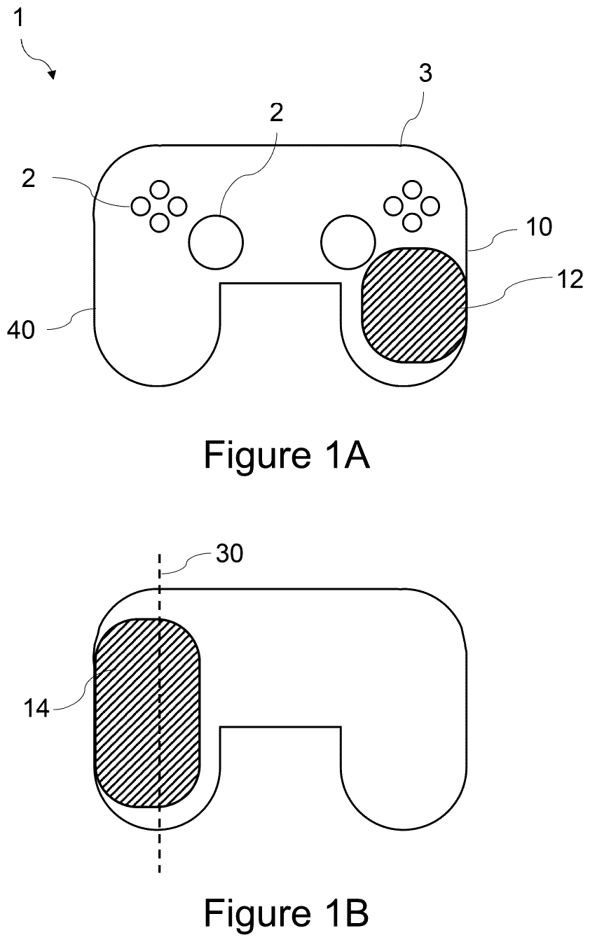

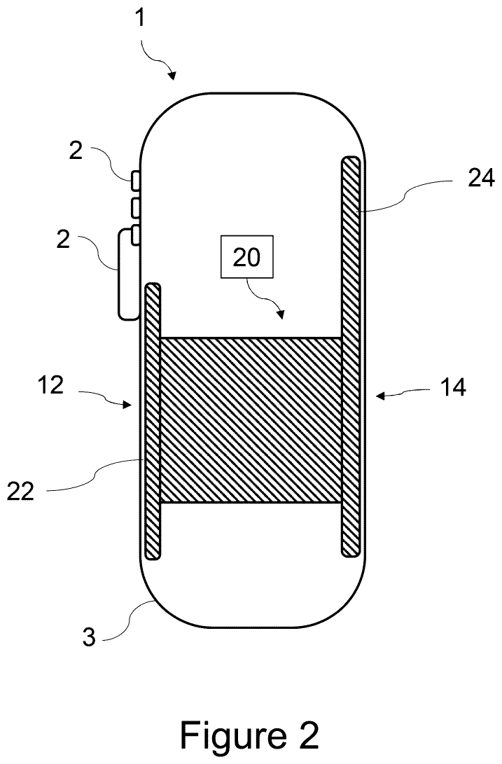

Referring to FIGS. 1A and 1B, a controller 1 for a video game system is shown in a plan view. FIG. 1A shows the front of the controller 1 and FIG. 2B shows the back of the same controller 1. The controller 1 is a gamepad comprising an exterior case 3 including a first handle 10 and an opposing second handle 40 for a user to hold the controller 1. Input elements 2 such as buttons and analogue sticks are provided on the exterior of the controller 1 as shown in FIG. 1A.

The first handle 10 includes a first region 12 and second region 14 which are configured to be contacted by the user when they hold the controller 1. For example, these first and second regions 12, 14 may be ergonomically designed such that the controller 1 can be comfortably held and the input elements 2 easily actuated by the user when they hold the controller 1 at the first and second regions 12, 14. FIG. 1A shows the first region 12 on the front of the controller, and FIG. 1B shows the second region 14 on the back of the controller, such that when the controller 1 is held with the front of the controller 1 facing the user, the first region 12 is a palm region which contacts the palm of the user and the second region 14 is a finger region which contacts at least one finger of the user.

FIG. 2 shows a cross-sectional side view of the controller 1, with the cross-section being through the first handle 10 along the line 30 shown in FIG. 1B. The cross-sectional view of the controller 1 shows the interior of the exterior case 3, illustrating the heat transfer module 20 housed within the exterior case 3 and extending across the controller 1 between the first region 12 and the second region 14. The heat transfer module 20 comprises a cooling region 22 and a heating region 24, with the heat transfer module 20 being configured to transfer heat from the cooling region 22 to the heating region 24. As the cooling region 22 is arranged at the first region 12 and the heating region 24 is arranged at the second region 14 this means the heat transfer module 20 will transfer heat from the first region 12 to the second region 14. In use, when the controller 1 is being held by a user, the user will experience localised cooling where they are contacting the first region 12 and localised heating where they are contacting the second region 14. In the example of FIG. 2, the first region 12 is a palm region and the second region 14 is a finger region, such that the cooling region 22 of the heat transfer module 20 is arranged at the palm region and the user's palm will be cooled, and the heating region 24 of the heat transfer module 20 is arranged at the finger region and the user's finger(s) will be heated.

The heat transfer module 20 may be implemented in various configurations. For example, the heat transfer module 20 may be a thermoelectric cooler. This is a device which utilises the Peltier effect to transfer heat between two different materials when an electric current flows through them. Although thermoelectric coolers are often dismissed due to their disadvantages, such as being less efficient than some other cooling and heating methods like vapour compression refrigeration, thermoelectric coolers have been found to be particularly well suited for use in the present invention.

Thermoelectric coolers can be flexibly shaped with a compact structure, comprising no moving parts or liquids which may break or cause other faults in the controller 1. In addition, thermoelectric coolers allow the heat transfer in the controller to be finely controlled and adjusted. For example, by activating or deactivating the thermoelectric cooler, adjusting the rate of heat transfer (e.g. by adjusting the current applied to the thermoelectric cooler), and changing the direction of heat transfer (by adjusting the direction of the current flow). A temperature sensor, such as a thermocouple, may be included in the controller 1 and configured to measure the temperature of the controller 1 (e.g. at the first region 12 or the second region 14) to determine if and how the thermoelectric cooler.

The thermoelectric cooler is an active heat transfer module 20 (or an active component of the heat transfer module 20) which uses input power to transfer heat between regions. In other embodiments, the heat transfer module 20 may comprise a passive heat exchanger which does not require power to transfer heat.

For example, the passive heat exchanger may comprise a sealed reservoir containing a heat transfer liquid that has a higher heat transfer coefficient than the handle 10 of the controller 1; this will provide continuous, unpowered heat transfer between the heating and cooling regions 24, 22. In another example, the passive heat exchanger may be a solid heat conductor, such as copper, extending between the heating region 24 and the cooling region 22. This will provide continuous, unpowered heat transfer between the heating and cooling regions 24, 22 without any moving parts or liquids.

Regardless of how the passive heat exchanger is implemented, it should have a higher heat transfer coefficient than the handle 10 of the controller 1, such that heat is transferred through the passive heat exchanger more readily than through other parts of the handle 10 of the controller 1. For example, more readily than the exterior case 3 which the user may hold during use.

The exterior case 3 of the controller 1 may be configured to facilitate efficient heat transfer between a user and the heat transfer module 20 of the controller 1. For example, the first and second regions 12, 14 may comprise openings in the exterior case 3 where the cooling region 22 and heating region 24 respectively extend into, allowing direct contact between the user and the heat transfer module 20. In another example, the thickness of the exterior case 3 is relatively thin at the first and second regions 12, 14 of the handle 10, such that the cooling and heating regions 22, 24 are arranged close to the exterior surface of the exterior case 3 where the user will contact the case 3. One or more thermal insulators may also be arranged within the exterior case 3 of the controller 1, for example around the heat transfer module 20, to shield other components, such as a PCB or battery, from temperature variations caused by the heat transfer module 20.

The example in FIGS. 1A, 1B and 2 describes a single heat transfer module 20 transferring heat from a first region 12 of a first handle 10 to a second region 14 of the first handle 10. If transfer of heat across the second handle 40 is also desired, then the same heat transfer module 20 may have a second cooling region and a second heating region, where these regions are respectively arranged at a third region of the second handle 40 and a fourth region of the second handle 40, such that a single heat transfer module 20 is configured to distribute heat on both the first and second handles 10, 40. Alternatively, the controller 1 may include a second heat transfer module which is used to transfer heat between the third and fourth regions of the second handle independently of the first handle 10 and the (first) heat transfer module 20.

Having described aspects of the disclosure in detail, it will be apparent that modifications and variations are possible without departing from the scope of aspects of the disclosure as defined in the appended claims. As various changes could be made in the above methods and products without departing from the scope of aspects of the disclosure, it is intended that all matter contained in the above description and shown in the accompanying drawings shall be interpreted as illustrative and not in a limiting sense.

1. A controller for a video game system, the controller comprising:
an exterior case comprising a handle configured to be held by a user, the handle comprising a first region and a second region; and
a heat transfer module configured to transfer heat from a cooling region to a heating region, the cooling region of the heat transfer module being arranged at the first region of the handle and the heating region of the heat transfer module being arranged at the second region of the handle.

2. The controller of claim 1, wherein the first region of the handle is a palm region configured to contact a palm of the user when the controller is held.

3. The controller of claim 2, wherein the second region of the handle is a finger region configured to contact at least one finger of the user when the controller is held.

4. The controller of claim 3, wherein the heat transfer module is configured to transfer heat from the palm region to the finger region.

5. The controller of claim 1, wherein the heat transfer module is housed within the exterior case.

6. The controller of claim 5, wherein a thickness of the exterior case at at least one of the first region or the second region is lower than an average thickness of the exterior case.

7. The controller of claim 1, wherein the cooling region and the heating region of the heat transfer module are arranged on an exterior region of the controller and the heat transfer module extends through the controller between the cooling region and the heating region.

8. The controller of claim 1, wherein the heat transfer module comprises a thermoelectric cooler.

9. The controller of claim 1, wherein the heat transfer module comprises a passive heat exchanger, the passive heat exchanger having a higher heat transfer coefficient than the handle of the controller.

10. The controller of claim 9, wherein the passive heat exchanger comprises a solid heat conductor extending between the heating region and the cooling region.

11. The controller of claim 9, wherein the passive heat exchanger comprises a sealed reservoir extending between the heating region and the cooling region, the sealed reservoir containing a heat transfer liquid having a higher heat transfer coefficient than the handle of the controller.

12. The controller of claim 1, further comprising a temperature sensor configured to measure a temperature of at least one of the first region or the second region of the handle.

13. The controller of claim 1, wherein:
the handle is a first handle and the exterior case further comprises a second handle configured to be held by the user at the same time as the first handle, the second handle comprising a third region and a fourth region;
the heat transfer module is further configured to transfer heat from a second cooling region to a second heating region, the second cooling region of the heat transfer module being arranged at the third region of the second handle and the second heating region of the heat transfer module being arranged at the fourth region of the handle.

14. The controller of claim 13, wherein the heat transfer module is further configured to transfer heat from the cooling region and the second cooling region to the heating region and the second heating region.

15. The controller of claim 1, further comprising:
a printed circuit board (PCB) housed within the exterior case; and
a thermal insulator arranged between the heat transfer module and the PCB.

16. The controller of claim 15, wherein the PCB comprises circuitry for operation of the controller.

17. The controller of claim 16, wherein the thermal insulator is arranged to protect the circuitry from temperature variations caused by the heat transfer module.

18. The controller of claim 1, wherein the controller is at least one of a gamepad, a joystick, a steering wheel, a yoke, or a remote.

19. A video game system comprising a base unit and the controller of claim 1.
